(19) United States
(12) Patent Application Publication
(10) Pub. No.: US 2003/0110186 A1
(43) Pub. Date: Jun. 12, 2003

(54) Dynamic generation of personalized presentation of domain-specific information content

(76) Inventors: Michael Markowski, Tallahassee, FL (US); Lawrence C. Hutson, Sarasota, FL (US); Dennis Warner, Flushing, NY (US); Steven W. Poser, Upper Saddle River, NJ (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/133,022

(22) Filed: Apr. 26, 2002

Related U.S. Application Data
(60) Provisional application No. 60/286,555, filed on Apr. 26, 2001.

(51) Int. Cl. G06F 17/60; G06F 15/16

(52) U.S. Cl. 707/104.1; 705/7; 709/205

(57) ABSTRACT

A method and system for delivering news reports based on the occurrence of predefined events in a predetermined news domain. The method comprises acts of collecting domain-specific news information; monitoring the domain-specific news information for the occurrence of one or more predefined events; and upon the occurrence of one of said predefined events, generating a news report relating the predefined event in prose assembled from pre-established templates. Generating a news report may comprise relating the predefined events in prose assembled from pre-established templates in multiple languages.

Priority is claimed under 35 U.S.C. §119(e) from provisional application serial No. 60/286,555, filed on Apr. 26, 2001.

### FIELD OF THE INVENTION

This invention relates to the gathering, delivery and presentation of information. More particularly, the invention relates to automated and semi-automated collection of information, parsing the information, and distributing customized reports to users using a variety of media.

### BACKGROUND OF THE INVENTION

An overwhelming amount of information can be accessed today using numerous forms of electronic media and communication channels. Both general purpose and specialized media outlets are available in print, television, the Internet and its World Wide Web, and other emerging media outlets.

With so much information available, and with most individuals having only limited time available to review this information, a need exists for processing the available information into a manageable and useful form. Currently, much of the information a user receives, whether from generalized or specialized media or other sources, is either not of particular interest to the user or is redundant. Furthermore, users cannot always access the type of content they need over a convenient medium. For example, a user may commonly need to subscribe to a particular publication in order to receive a small amount of information that the user desires. This small amount of useful information is often not found in isolation or in a format available to the user over a convenient medium. For example, users may not be able to access a certain type of information that they need using their mobile communication devices because the information required is only available in a newspaper.

Furthermore, current and archived content relating to a given topic are often disassociated from one another, and it is difficult for a user reviewing a current news item, for example, to access relevant information related to that new information item. Thus, there is a need to collect related information that is useful to a particular consumer of information, and separate therefrom information desired by the consumer of the information.

Often, more important to the user than obtaining raw information is obtaining a contextual interpretation of that information. In some specific field-of interest domains, newsletters and other services are available, written by specialists, for distributing news analysis along with factual reporting. These services are expensive, as the services of skilled professionals who perform the analysis and reporting are costly. A need exists for less costly delivery of interpretive news reports.

Some systems at present provide subscription services to information consumers. Such services typically require the consumer to subscribe to channels, the channels containing information generally sorted by topic. These services are commonly unsophisticated, self-service products, that do not perform an adequately efficient job of filtering and organizing information available to the consumer. Other solutions have been found to be excessively time consuming and costly, and may involve tedious information gathering and evaluation by customer service representatives.

In addition to the limitations described above, present systems fail to provide the useful information in a flexible fashion, such as in a choice of languages and delivery media. Providing information streams in multiple languages typically is quite costly as machine translations are at most useful for providing a rough draft material needing human editing.

### SUMMARY OF THE INVENTION

The present invention addresses the needs mentioned above, and provides at least a partial solution to them, including the problem of information congestion and redundancy, at least in appropriate domains. The invention also provides for efficient means for collecting and distributing relevant useful information based on specific users' preferences. Such information may include news about the occurrence of triggering events previously identified by users. The information may be provided to the users over a variety of distribution channels and media and in a variety of formats and languages. Typically, the information relates to a specific field-of-interest domain (e.g., stocks, sports, local news, technology news, etc.) and is presented with some contextual interpretation specific to the domain. Such interpretation may, for example, include historical comparisons.

According to a first aspect, the invention involves a method for delivering news reports based on the occurrence of predefined events in a predetermined news domain, comprising: collecting domain-specific news information; monitoring the domain-specific news information for the occurrence of one or more predefined events; and upon the occurrence of one of said predefined events, generating a news report relating the predefined event in prose assembled from pre-established templates. Generating a news report may comprise relating the predefined events in prose assembled from pre-established templates in multiple languages. The use of pre-established templates provides that the linguistic validity of the text is assured and avoids the problems associated with trying to generate accurate free-form translations in real-time or near real-time.

Generating a news report may comprise executing conditional operations to determine prose elements to include in said report based at least in part on a value of a datum related to the occurrence of at least one of said predefined events.

Collecting domain-specific news information may include collecting said information from multiple sources, at least one of which supplies historical information and at least one of which supplies current information, and reconciling the information from the multiple sources. It may further include aggregating said information according to a predetermined hierarchy of relationships. The method may be applied to information pertaining to company financial and stock performance and the events monitored may include a financial performance parameter or stock price crossing a predetermined boundary value. The hierarchy of relationships may group stock performance according to at least an industry and economy sector to which a company is assigned, based on its products or services.

The method also may include a user predefining one or more specified events to be monitored, upon the occurrence of which a news report is to be sent to the user.

Generating a news report may further include adapting the report for a multiplicity media and transmitting over each of said media a report adapted for that medium. Adapting the report for at least one of said media may include omitting at least a portion of information which is included in a report adapted for another medium.

The act of collecting domains specific news information may be performed automatically by a computer. Additionally, the act of monitoring the domain specific news information for the occurrence of one or more predefined events may also be implemented by a computer.

According to another aspect, the invention involves a computer program product for delivering news reports based on the occurrence of predefined events in a predetermined news domain, the predefined events relating to collected data from at least one data source. The computer program product comprises a computer readable medium having encoded therein instructions which when executed by a computer system cause the computer system to: monitor the domain specific news information for the occurrence of one or more predefined events; and based, at least in part, upon the occurrence of one of said predefined events generate a news report relating the predefined event in prose assembled from a pre-established templates.

The instructions which generate a news report may includes instructions which relate the predefined events in prose assembled from pre-established templates in multiple languages. The instructions which cause the computer system to generate a news report may also include instructions which execute conditional operations to determine prose elements to include in the report based at least in part on a value of data related to the occurrence of at least one of the predefined events. At least part of the domain specific news information may be collected automatically and the computer program product may include instructions which collect said domain specific news information from multiple sources, at least one of which supplies historical information and at least one of which supplies current information.

The computer program may also reconcile at least part of the domain specific news information from the multiple sources. The computer program product may also include instructions which aggregates the domain specific news information according to a predetermined hierarchy of relationships. The domain specific news information may pertain to company financial and stock performance and the hierarchy relationships could group stock performance according to an industry and an economy sector to which a company is assigned, based on its product or services. The computer program product may also adapt the news report for multiplicity of media and transmit the adapted news story over each of the media. Alternatively, a user may specify a specific medium selected from a list of available media and the report may be transmitted over the selected medium.

According to another aspect of the invention, a system for delivering news reports based on the occurrence of predefined events in a predetermined news domain is provided. The system comprises: at least one set of data for storing domain specific news information; a first processor adapted for collecting the domain specific news information from the at least one set of data; a second processor adapted for monitoring the domain specific news information for the occurrence of one or more predefined events; and a third processor adapted for generating, based at least in part upon the occurrence of one of said predefined events, a news report relating the predefined event in prose assembled from pre-established templates.

In one embodiment, the first processor, the second processor and the third processor may be the same processor. The first processor may be adapted for checking data from the at least one data set for errors and resolving at least some discrepancies in the data from the at least one data set. The system may further comprise at least one time series data structure for storing instance values of data from the at least one data set over a period of time.

The system may further comprise at least one database for storing data collected from the at least one data set. Additionally, the third processor may be further adapted for relating the predefined events in prose assembled from pre-established templates in multiple languages.

### BRIEF DESCRIPTION OF THE DRAWINGS

The invention will be better understood from the detailed description which follows, which should be read in conjunction with the accompanying drawings, in which:

FIG. 1A is a block diagram of an exemplary system for practicing the present invention;

FIG. 1B is a flow chart of an exemplary method for practicing the present invention;

FIGS. 2A-2B are block diagrams of example aggregation hierarchies for use with the present invention;

FIG. 3 is a block diagram of a report composition process for use in the system of FIG. 1; and

FIGS. 4-6 are illustrative news reports produced in accordance with the inventive method in, respectively, English (FIG. 4), Spanish (FIG. 5) and German (FIG. 6).

### DETAILED DESCRIPTION

In one illustrative embodiment of the invention, domain-specific data is collected from a plurality of sources. The data is then checked for errors or redundancies and stored in a database. As data is received, in can be monitored for the occurrence of specific events. If it is determined from monitoring the data the one of these events has occurred, a news story can be automatically generated using a pre-established template.

An illustrative example according to the invention will now be described. It should be appreciated that the invention may be used in many different domains. For example, the information could relate to domains such as, for example and without limitation, sports, financial information, weather, technology, etc. Furthermore, it should be understood that the terms “comprising”, “including”, and “having”, as used herein, are intended to be synonymous and open-ended, that is, they mean “including but not limited to”.

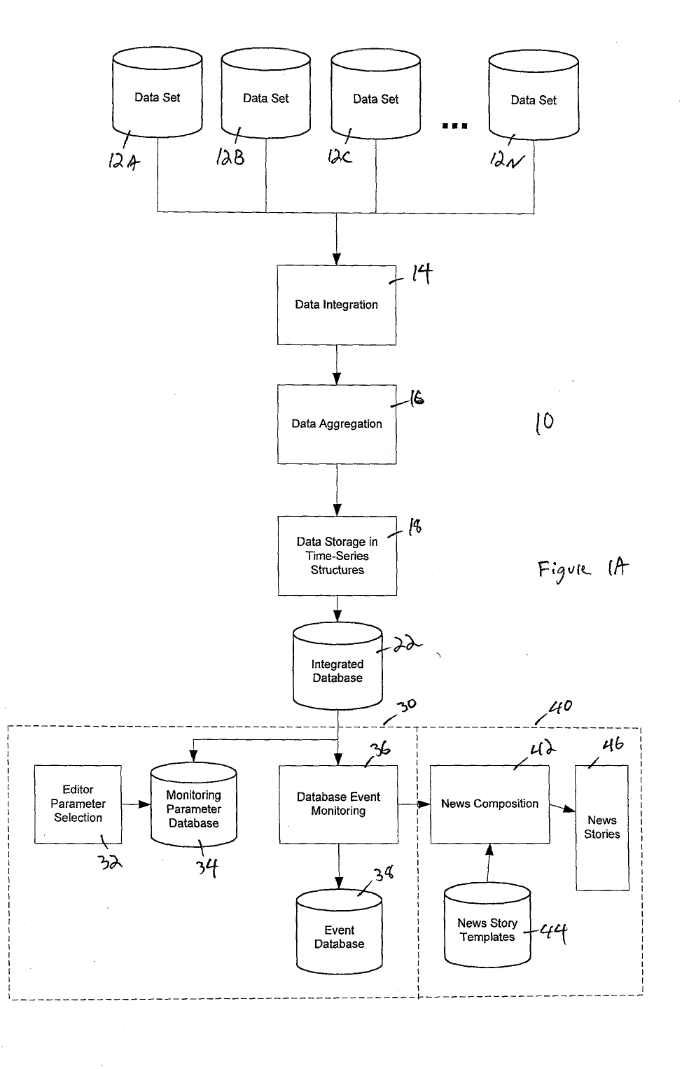

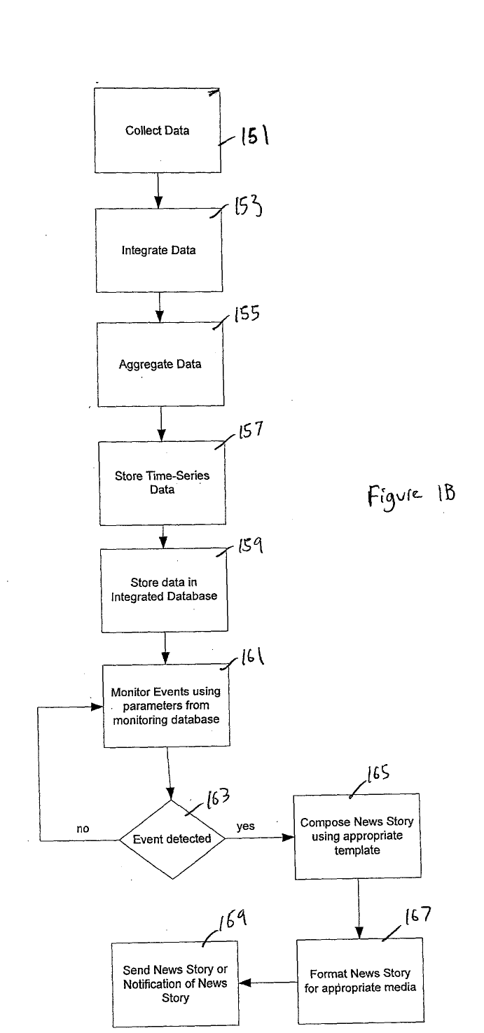

Turning to FIGS. 1A and 1B, there is shown a block diagram and an accompanying flow chart for a system 10 according to the invention, for the gathering, delivery and presentation of information. It should be understood that the modules illustrated in FIG. 1A may be computer processes running on a single processor or multiple processors. As mentioned above, the information being processed by system 10 may pertain to many different domains. From external sources of information (preferably in electronic form), a plurality of data sets, 12A-12N, are collected, as shown in block 151 of FIG. 1B. If the domain for which data is being collected is, for example, company financial and stock information, four data sets could, for example, be used. A first data set could be a stream of live stock market data from any suitable commercial source, providing “tick by tick” stock transaction information (i.e., the volume and price of each stock sale). A second data set could be a collection of closing stock prices (i.e., the closing price of each stock) from the public stock exchanges at the end of each trading day. A third data set 12C could be a collection of predetermined data on the financial performance of each publicly traded company (or at least most of them), taken from their financial reports as published to the appropriate regulatory agencies (e.g., the U.S. Securities and Exchange Commission). The third data set may be purchased in electronic form or assembled manually, or a combination of the two. A fourth data set could be a collection of press releases from public companies and announcements from other sources (e.g., stock analysts).

If one were collecting information in the domain of sports, for example, one data set may contain information with live updates from games. A second data set may contain final box scores from the end of games. A third data set may contain information about a player's status. For example, the third data set may indicate if a player is on the injured list, what type of injury the player has, and how long he will be out. A fourth data set could contain news stories about sports.

Collected information can be integrated, as shown at block 153 of FIG. 1B. A data integration module 14 (exemplified as a process corresponding to instructions executing on a suitable computer, not shown) collates and/or cross-references the information in data sets 12A-12N.

One function of data integration module 14 is to identify the data. If the system were operating in the domain of company financial and stock performance data, the data integration module 14 could identify to which company the data pertains. For example, data integration module could determine that a press release from one of the data sources is a Microsoft Corporation press release. Likewise, if the system were operating in the domain of sports, data integration module 14 could determine that a box score relates to two particular teams.

A second function of the data integration module is to check the incoming data for errors and to resolve discrepancies in data. For example, if data integration module 14 receives a baseball box score that indicates that a player had twenty stolen bases in one game, data integration module could automatically determine that this is most likely an inaccurate number, since it is a highly irregular statistic. Data integration module 14 could make such determinations in a variety of ways. For example, data integration module 14 could compare the newly received data to an average of that data over time (i.e., the player's average number of stolen bases per game over the past 5 seasons) and determine how much the received data differs from the average. As another example, data integration module 14 could reject all data that exceeds a predetermined threshold.

Likewise, discrepancies between data from different data sets can also be resolved. For example, in the financial domain, if the last stock price received from the “tick by tick” stock data does not match the closing stock price from the end of day market data, data integration module 14 can identify and attempt to resolve this discrepancy. Experience reveals that the majority of such discrepancies result from typographic errors such as transposition of digits in numbers. Discrepancies may be resolved by a human operator or by computer programs, or by a combination of the two. Correct data may be obtained in a variety of ways, including reference to an authoritative source or when three or more sources are available for a particular datum, and one source disagrees with the majority of sources, by disregarding the data from the discrepant source and replacing it with the data from the other, concurring sources (i.e., the majority rules).

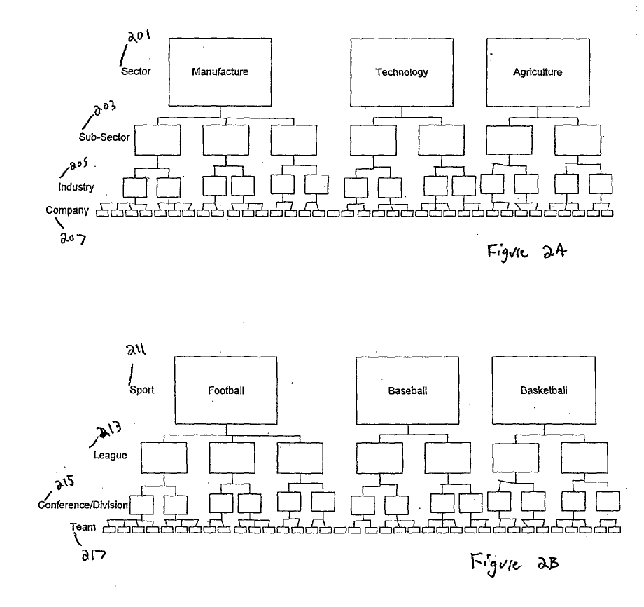

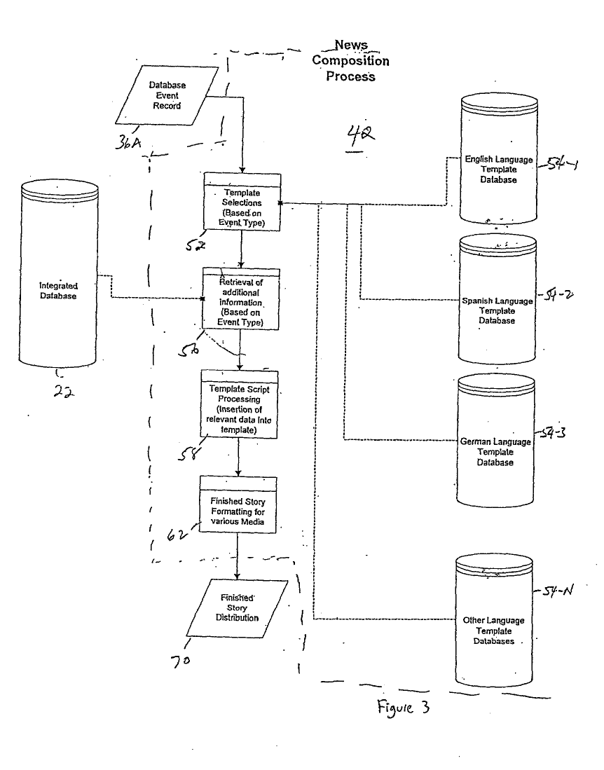

Once the data has been integrated by data integration module 14, information is then aggregated, as shown at block 155, in a number of ways in a data aggregation module 16 (also a software process executing on a computer, not shown). Aggregation of data allows data to be compared to similar data. FIGS. 2A and 2B illustrate one method by which data may be aggregated. As shown in FIGS. 2A and 2B a hierarchy is defined for classifying data. In the financial domain, data may be first classified into a sector 201, then a sub-sector 203 within that sector. Next, the data may be classified into an industry 205 within the sub-sector, and finally a company 207 within that industry. The hierarchy may be predefined and updated periodically. Likewise, it may be changed from time to time and company position in the hierarchy may be changed (such as by changing its industry assignment). FIG. 2B illustrates a similar hierarchy for the sports domain. This aggregation allows one to compare, for example, a company's performance with other companies in the same industry, sub-sector, sector, etc. Similarly, a company's performance with the average for its industry, sub-sector, or sector. Likewise, in the sports domain, a player's statistics could be compared with averages from the team, conference, or league. It should be appreciated that the hierarchies illustrated in FIGS. 2A and 2B are given only as examples. The hierarchies are not limited to any specific number of levels or types of groupings. The characteristics of the hierarchy may depend on the domain being analyzed and the types of groupings or comparisons that are desired.

The resultant integrated and aggregated data then preferably is processed into a time series database structure(s), as shown at block 157, by a module 18 (again exemplified as a computer-implemented process). A suitable time-series database program for this purpose is TimeSquare from Soliton Associates Limited of Toronto, Canada, though it will be appreciated that there are other suitable commercial software products that may be used and that a custom database program may be written, instead. The time-series data structures store instance values of various data parameters over time. The time-series data structures are dependent on the type of data that is being stored. For example, one data structure (e.g., a table) may store the end of day closing stock price of a company on a daily basis, while another data structure may store earnings of the company on a quarterly basis. The resultant cleaned-up, integrated, aggregated, time-series data is stored in a time-series database 22, referred to as the Integrated Database (block 159).

A database mining engine 30 mines the contents of Integrated Database 22 and provides to a communication engine 40 data and instructions to cause the communication engine to compose and send appropriate news reports 46 to users (blocks 161 and 163). The database mining engine receives from an input subsystem 32 user requests for parameters and combinations of parameters (events) to be monitored and reported. These parameters and combinations of parameters can be as simple as the price of AT&T shares hitting a target amount (high or low) or as complex as imagination can conceive and a search engine can accept; for example, the price of AT&T shares falling more than x% over any decline in the communications sector index, provided that AT&T shares had not appreciated more than y% over the past month and there was no press release indicating that AT&T earnings would be more than z dollars below forecast. This, of course, is just one of innumerable possible examples and is not meant to imply that the combinations of parameters need relate to only one stock. For example, a user may wish to know when a first stock falls but another rises. Similar parameters may be used in the sports domain. For example, a user may wish to receive a news story when a player's field goal percentage increases z% over a y game stretch. Or, a user may wish to be notified when a player goes on the injured list.

All of the various users' criteria for generating news alerts are entered and edited through the input subsystem 32 and the input subsystem feeds those criteria into a monitoring parameter database 34. The input subsystem may include, for example, a web site accessible via a conventional browser client. At the web site, a user may enter trigger conditions or events to be reported upon this occurrence, the language and media for reporting, etc. The monitoring parameter database holds the boundary values to be monitored and the parameters to which they apply, as well as the identity of the user who is to be notified if appropriate trigger events occur, such as when parameter boundaries are crossed (i.e., values traversed). In one embodiment, the monitoring parameter database and a database event monitoring process 36 associated therewith may check the Integrated Database periodically to determine if any of the criteria specified by the user have been met. The frequency with which parameters are checked may depend on how often the parameters used to generate events are updated. For example, an event based solely on whether the earnings of a company exceed a certain amount may only need to be checked once per quarter since earnings are published by companies on a quarterly basis. However, an event based on the stock price of a company may be checked much more often during trading hours, since the stock price is continually changing, while it need not be checked at all during non-trading hours. Alternatively, all parameters could simply be checked once per day or once per week or other intervals. In another embodiment, the monitoring parameter database and a database event monitoring process 36 associated therewith receive a feed of information from the Integrated Database each time a datum value changes. The database event monitoring process determines whether the datum value change should generate a reportable event. If so, the event is recorded in an event database 38 and it is reported to communication engine 40.

Integrated Database 2, Monitoring Parameter Database 34, Event Database 38, Time-Series Structures 18 and News Story Templates 44 are depicted as separate databases in FIG. 1. However, it should be understood that these databases may be implemented as one database in a single database management system (DBMS), many databases in a single DBMS, databases in many DBMSs, or any combination thereof. Likewise, any type of commercial or custom database or DBMS could be used.

Communication engine 40 processes the event data into a news story reported in a form useful to a user or subscriber (block 165). It does so by creating a textual report into which numeric (or other) data values are inserted so that information is conveyed in prose, in meaningful phrases, sentences and paragraphs. The same data may be used to create reports in multiple languages, but those reports may not be literal translations of each other. The report for each language is separately assembled. A news composition process 42 analyzes the data and executes a framework of conditional text assembly, drawing from a multilingual and preferably multi-subject database 44 to create each report 46, clause by clause and sentence by sentence. Preferably each such report includes a first portion which states what occurred and a second section that interprets the event in a historical context. The report also my suggest further action to the recipient.

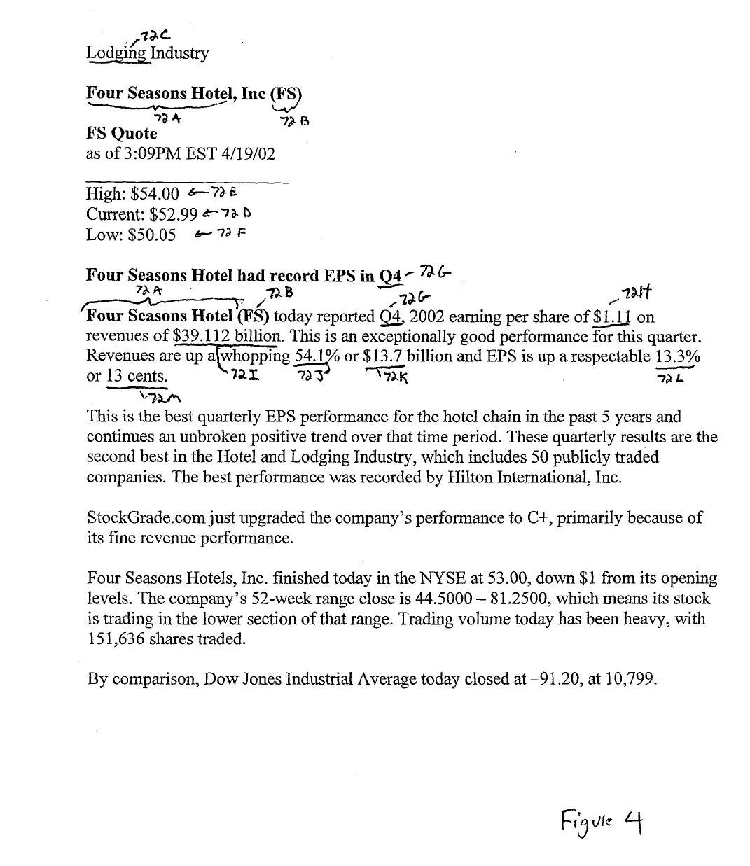

An exemplary news composition process 42 is depicted in FIG. 3. Composition of a news report or set of news reports is initiated by receipt of a database event record 36A from the database event monitoring process 36. The event record is a message indicating that there has occurred an event for which the system has been monitoring (e.g., a value of a monitored variable exceeding a boundary or threshold value), together with relevant parametric content. Based on the type of event, a template selection process 52 references the various N language databases 54−1. . . 54−N and identifies and retrieves templates that will be appropriate, per previously determined event-template relationships. For some events, information will be retrieved by process 56 from the Integrated Database 22 for use in augmenting the information in the database event record. For example, historical information and comparative information (such as industry sector comparisons) is obtained form the Integrated Database based on the entity to whom the event relates (e.g., the company whose change in share price is being reported). A template script processing process 58 inserts the relevant data into the retrieved templates and assembles the report. The report actually may be assembled from multiple templates strung together, each forming a section of the total report. For example, a first section from a first template might report that a stock price has hit a new high for the year and a second template might be called conditionally to select a template that reports good news instead of one that reports bad news. Then a third section from yet a third template might provide a comparison to stocks in the same industry or sector, or both. The finished stories in the various languages of the template databases then are formatted by process 62 for reporting via a variety of media (block 167). For example, reports to be distributed to cell phone users might be truncated by omitting a section (e.g., the third section in the example just given), to conserve bandwidth, service charges and scrolling on a small screen. The finished stories are distributed via a finished story distribution subsystem 70 that interfaces with appropriate communications links to broadcast or send the information to appropriate subscribers or other users (block 169).

News stories may be generated on occurrence of one of an event and then sent to a user over the desired media. For example, the story could be e-mailed in plain text to a user, e-mailed in HTML format to a user, or sent to a user's wireless device. Any suitable media could be used to send news stories. Alternatively, a news story may be generated on the occurrence of an event and a notification that the news story is available could be sent to the user using any of the media described above. Then, the user could retrieve the story whenever desired by, for example, connecting to a world wide web server with a conventional web browser. In yet another way of distributing news stories, the notification of the event could be sent to the user without generating the news story. In this method, the news story would be generated later when a user responds to the notification and requests the news story by, for example, connecting to a world wide web server with a conventional web browser. In this method, news stories are generated based upon the occurrence of a user's request to view the story in addition to the occurrence of the event.

FIGS. 4-6 provide corresponding exemplary reports generated by this system in a number of (here, three) different languages (here, English, Spanish and German, respectively) on pages of a web site, to report the same information in response to a single database event record. As seen in FIG. 4, the event in this example is the issuance of a (fictitious) report by Four Seasons Hotels, Inc. (stock symbol FS), regarding its earnings for the fourth quarter of the year 2002. The following raw data is supplied to report composition process 40, either from the event record 36A or the Integrated Database 22:

The name of the entity for which the report is generated, 72A, that entity's stock trading symbol 72B, the industry 72C into which the entity has been classified, the current market price of a share of the company's stock 72D, the days high price for the stock 72E and low price for the stock 72F; the period 72G for which the event occurred; the nature or type of event (not shown, but in this example an earnings report); data pertaining to the event (which will depend upon the type of event), such as the earnings per share (EPS) 72H and revenues 72I; information (not shown) from which comparison calculations can be performed and presented, such as comparable information for prior periods of time. With this information, the template script processing process assembles the text of the report. Thus it reports in a versed sentence or section for use in an earnings report. The template sentence would, in this example, be “[72A] ([72B]) today reported [72G] earnings per share of [72H] on revenues of [721].” In a second sentence or section, the report inserts the statement “this is an exceptionally good performance for the quarter.” Note that there is no data required to be inserted in that section. The template for the section is a complete sentence chosen from a library of sentences that might follow at this point in the story. The selection of the particular sentence to use is conditional upon the data used to assemble the first sentence. Similarly, conditional operations may be used to evaluate the data and select, based on the specific values of the data, an appropriate sentence. For example, the data can be analyzed to determine which of the candidate sentences can be used in the second section. Thus, “this is an exceptionally good performance for the quarter” is not a statement that would be made if the earnings per share had been down from the previous quarter or previous year. The data analyzed to determine the sentence to use in the second section of the report may, for example, be the results of the calculations shown in the third sentence of this paragraph. A calculation is made as to the percentage increase of revenues and the percentage increase of EPS compared to the previous quarter and then some matrix or algorithm is applied to select adjectives for describing the performance. In this instance, the template for the third sentence might, for example, be “Revenues are [A] [B] [72J] or [72K] and EPS is [C] a [D] [72L] or [72M]”. The square brackets identify material to be inserted based on values of the evaluated contents between the brackets. The letters A-D refer to adjectives to be inserted conditionally in response to appropriate calculations. The reference numerals or numeral-letter combinations in brackets denote raw or computed numbers. The adjectives are selected from those available based upon computation to interpret the significance of the numbers they are characterizing. It some situations, it may be to present factual information without expressing an opinion or characterization of the data. In these situations, sentences such as “This is an exceptionally good performance for this quarter” may be omitted.

In like fashion, a next paragraph is assembled piece by piece from the event-related data and historical data from the Integrated Database 22. For example, the first sentence of the second paragraph may be either a complete sentence extracted in response to an analysis of triggering conditions or it may be parts together based on conditions. For example, the word “best” may be selected from among a group of candidates that would include also “second best”, “worst”, and “second worst”. If one of those four possible adjectives does not fit, the sentence might not be used at all. A different sentence might be selected from the template. There is no single way of expressing an analysis of this particular event, of course. Thus, the language of the report and the parsing together of the report is a matter of design detail and not a limitation of the invention. The third paragraph of the report is selected from a library of potential statements about the impact of the event data on an “analyst” service grading of the stock or simply company performance.

The fourth paragraph of the report addresses the performance of the company's stock and relates current values to the 52-week range, as well as reporting trading volume. It is composed in a fashion similar to that of the other paragraphs.

Thus, the entire report of FIG. 3 has been generated automatically and without human intervention from the point that the occurrence of an event has been detected.

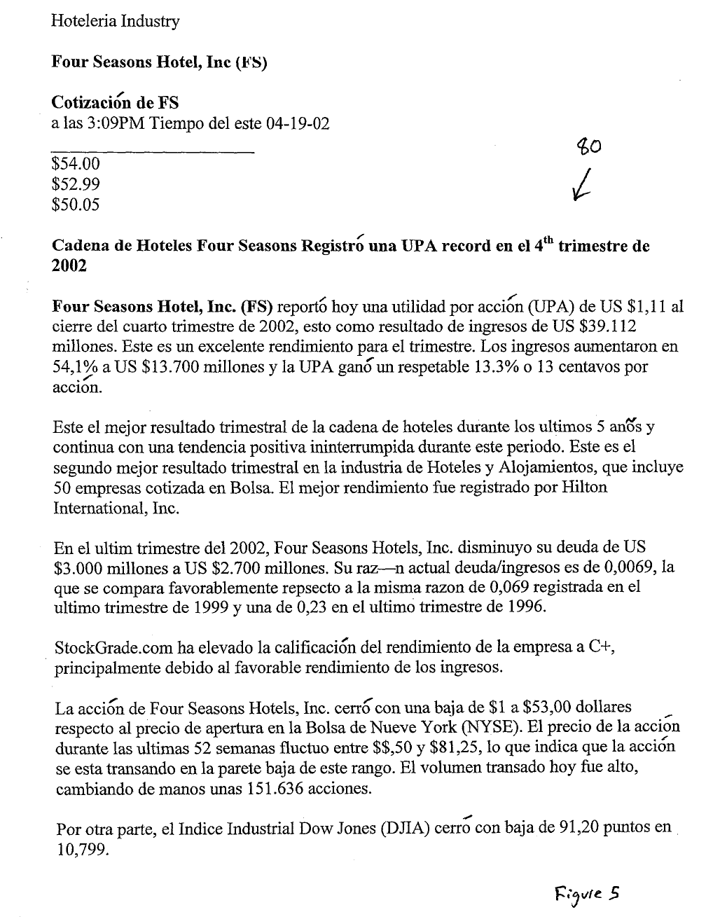

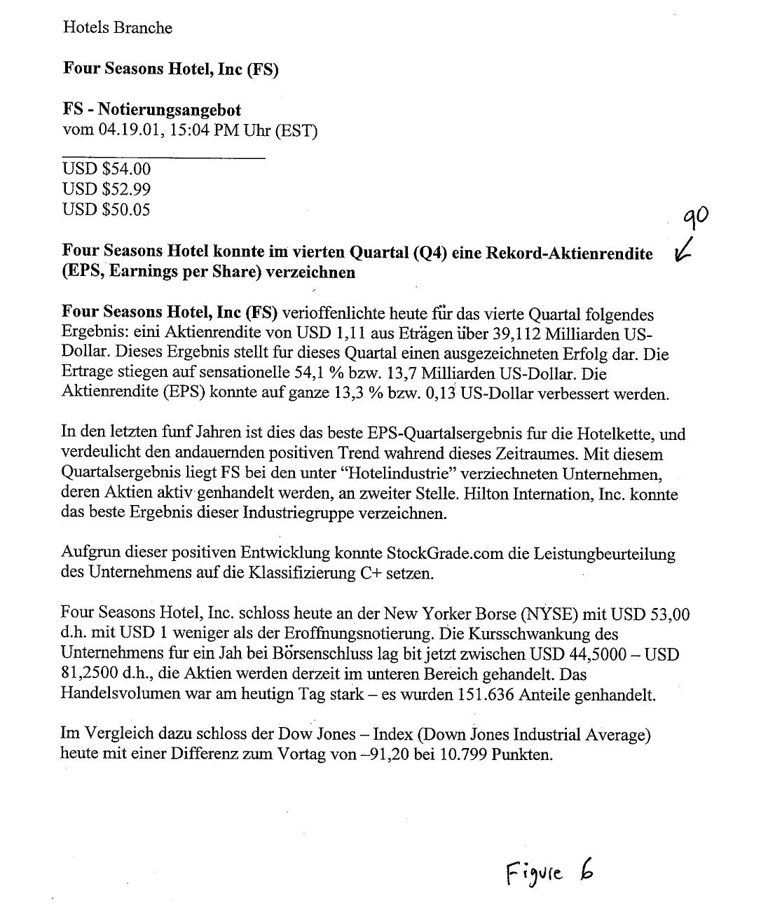

Turning to FIG. 5, a Spanish language report 80, comparable to the English language report of FIG. 4 is shown. Those familiar with both languages will notice immediately although the overall formats of the reports are similar, the Spanish report is not simply a literal translation of the English report. For example, information is reported in the third paragraph of the Spanish report about performance of Four Seasons Hotels, Inc. in the last quarter of 2000, including reduction of debit, not presented in the English report. This may, for example, be due either to custom or to financial reporting requirements in the Spanish language world. Thus, the parsing of a report in each language is done according to templates for that language. The German report 90 in FIG. 6 provides another illustration of how the same data may be presented in another language. In this particular example, the German translation follows the English report fairly closely without the additional content of the third paragraph of the Spanish report. It is not uncommon, however, that content that would be in multiple English sentences would end up in a single German sentence, though the drafter of the templates can structure a fairly parallel set of German sentences to English sentences if he or she desires the reports to have similar structure. Again, that is very much under the control of the template designer.

Having thus disclosed and explained the concept of the invention and its exemplary implementation, it will be readily appreciated by those skilled in the art that the foregoing discussion makes a presentation by way of example only and that it is not intended to be limiting. Various alterations and alternative embodiments will readily occur to those skilled in the art and are intended to be suggested and disclosed herein even though not set forth in full. For example, as stated previously, although the examples shown involve the presentation of a company's financial stock performance, the same system may be used, with minor modifications, to monitor and generate reports on various other genre (domains) of information. The incoming data might instead be sports data covering the performance of individual players and teams in one or multiple sports and provide news reports in response to the progress of a particular game, tournament, or other contests, for example. In such a situation, the processes of data integration by companies and securities and data aggregation by industry, industry group, etc., will be replaced by the parallel processes of data integration by teams and leagues and in the process of data aggregation might be unnecessary and thus omitted. The input data sources obviously would not be tick-by-tick stock market transactions and financial statement data and the like but would, instead, be the performance of a given athlete at whatever level of regularity is desired and team performance data as well as game location and time data and data relating to any other factors that might prove desirable to track. Those skilled in the art of information processing will readily see that reporting sports information can be accomplished with the same basic architecture shown for processing the generated reports on company and stock information. Likewise, they will appreciate that events from other realms also would lend themselves to reporting through this architecture. Accordingly, it is intended that the foregoing examples not be construed as limiting the nature and that the invention be limited only as required by the following claims and equivalents thereto.

What is claimed is:

1. A method for delivering news reports based on the occurrence of predefined events in a predetermined news domain, comprising acts of:
a. collecting domain-specific news information;
b. monitoring the domain-specific news information for the occurrence of one or more predefined events; and
c. based, at least in part, upon the occurrence of one of said predefined events, generating a news report relating the predefined event in prose assembled from pre-established templates.

2. The method of claim 1, wherein generating a news report comprises relating the predefined events in prose assembled from pre-established templates in multiple languages.

3. The method of claim 1, wherein generating a news report comprises executing conditional operations to determine prose elements to include in said report based at least in part on a value of a datum related to the occurrence of at least one of said predefined events.

4. The method of claim 1, wherein collecting domain-specific news information includes collecting said domain-specific news information from multiple sources, at least one of which supplies historical information and at least one of which supplies current information, and reconciling the domain-specific news information from the multiple sources.

5. The method of claim 4, wherein collecting domain-specific news information automatically.

6. The method of claim 4, further including aggregating said domain-specific news information according to a predetermined hierarchy of relationships.

7. The method of claim 1, wherein the domain-specific news information pertains to company financial and stock performance and the events monitored include a financial performance parameter or stock price crossing a predetermined boundary value.

8. The method of claim 7, wherein the hierarchy of relationships group stock performance according to at least an industry and economy sector to which a company is assigned, based on its products or services.

9. The method of claim 1, further including a user predefining one or more specified events to be monitored, upon the occurrence of which a news report is to be sent to the user.

10. The method of claim 1, wherein generating a news report further includes adapting the report for a multiplicity of media and transmitting over each of said media a report adapted for that medium.

11. The method of claim 10, wherein, for at least one of said media, adapting the report includes omitting at least a portion of information which is included in a report adapted for another medium.

12. The method of claim 1, wherein generating a news report further includes adapting the report for a medium selected by a user from a list of available media and transmitting over the selected medium a report adapted for the selected medium.

13. The method of claim 1, wherein the domain-specific news information pertains to sports news and statistics.

14. The method of claim 1, wherein the act of generating the news report further comprises generating the news report based in part upon a request from a user.

15. A computer program product for delivering news reports based on the occurrence of predefined events in a predetermined news domain, the predefined events relating to collected data from at least one data source, the computer program product comprising a computer-readable medium having encoded therein instructions which when executed by a computer system cause the computer system to:
a. monitor the domain-specific news information for the occurrence of one or more predefined events; and
b. based, at least in part, upon the occurrence of one of said predefined events, generate a news report relating the predefined event in prose assembled from pre-established templates.

16. The computer program product of claim 15, wherein the instructions which cause the computer system to generate a news report include instructions which relate the predefined events in prose assembled from pre-established templates in multiple languages.

17. The computer program product of claim 15, wherein the instructions which cause the computer system to generate a news report include instructions which execute conditional operations to determine prose elements to include in said report based at least in part on a value of a datum related to the occurrence of at least one of said predefined events.

18. The computer program product of claim 15, wherein at least part of domain-specific news information is collected automatically and the computer-readable medium further includes instructions which collect said domain-specific news information from multiple sources, at least one of which supplies historical information and at least one of which supplies current information, and reconciles at least part of the domain-specific news information from the multiple sources.

19. The computer program product of claim 18, further including instructions which when executed allow the computer system to aggregate said domain-specific news information according to a predetermined hierarchy of relationships.

20. The computer program product of claim 15, wherein the domain-specific news information pertains to company financial and stock performance and the events monitored include a financial performance parameter or stock price crossing a predetermined boundary value.

21. The computer program product of claim 20, wherein the hierarchy of relationships group stock performance according to at least an industry and economy sector to which a company is assigned, based on its products or services.

22. The computer program product of claim 15, further including instructions which when executed allow a user to predefine one or more specified events to be monitored, upon the occurrence of which a news report is to be sent to the user.

23. The computer program product of claim 15, wherein the instructions which cause the computer system to generate a news report further include instructions which when executed cause the computer system to adapt the report for a multiplicity of media and transmit over each of said media a report adapted for that medium.

24. The computer program product of claim 23, wherein for at least one of said media the instructions which cause the computer system to adapt the report include instructions which when executed by the computer system cause the computer system to omit at least a portion of information which is included in a report adapted for another medium.

25. The computer program product of claim 13, wherein the instructions which cause the computer system to generate a news report further include instructions which when executed cause the computer system to adapt the report for a medium selected by a user from a list of available media and transmit over the selected medium a report adapted for the medium.

26. The computer program product of claim 15, wherein the domain-specific news information pertains to sports news and statistics.

27. The computer program product of claim 15, wherein the instructions which cause the computer system to generate the news report include instructions which when executed cause the computer system to generate the news report based in part upon a request from a user.

28. A system for delivering news reports based on the occurrence of predefined events in a predetermined news domain, comprising:
a data integrator which receives at least one set of data containing domain-specific news information and collects the domain specific news information from the at least one set of data;
an event monitoring engine which monitors the collected domain-specific news information for the occurrence of one or more predefined events; and
a news composition engine responsive to the event monitoring engine, which generates, based at least in part upon the occurrence of one of said predefined events, a news report relating the predefined event in prose assembled from pre-established templates.

29. The system of claim 28, wherein the data integrator is further adapted for checking data from the at least one data set for errors and resolving at least some discrepancies in the data from the at least one data set.

30. The system of claim 28, further comprising at least one time-series data structure for storing instance values of data from the at least one data set over a period of time, wherein the at least one time-series data structure is monitored for the occurrence of said predefined events by the event monitoring engine.

31. The system of claim 28, further comprising at least one database for storing data collected from the at least one data set, wherein the at least one database is monitored for the occurrence of said predefined events by the event monitoring engine.

32. The system of claim 28, wherein the news generation engine is further adapted for relating the predefined events in prose assembled from pre-established templates in multiple languages.

33. An at least partially computer-implemented method for delivering news reports based on the occurrence of predefined events in a predetermined news domain, comprising acts of:
a. collecting domain-specific news information;
b. monitoring the domain-specific news information for the occurrence of one more predefined events; and
c. based, at least in part, upon the occurrence of one of said predefined events, generating a news report relating the predefined even in prose assembled by computer from pre-established templates.

34. The method of claim 33, wherein the act of collecting domain-specific news information is performed by a computer.

35. The method of claim 33, wherein the act of monitoring the domain-specific news information is automated and performed by a computer.

36. The method of claim 33, wherein generating a news report comprises relating the predefined events in prose assembled from pre-established templates in multiple languages.

37. The method of claim 33, wherein generating a news report comprises executing conditional operations to determine prose elements to include in said report based at least in part on a value of a datum related to the occurrence of at least one of said predefined events.

38. The method of claim 33, wherein collecting domain-specific news information includes collecting said domain-specific news information from multiple sources, at least one of which supplies historical information and at least one of which supplies current information, and reconciling the domain-specific news information from the multiple sources.

39. The method of claim 38, wherein collecting domain-specific news information automatically.

40. The method of claim 38, further including aggregating said domain-specific news information according to a predetermined hierarchy of relationships.

41. The method of claim 33, wherein the domain-specific news information pertains to company financial and stock performance and the events monitored include a financial performance parameter or stock price crossing a predetermined boundary value.

42. The method of claim 41, wherein the hierarchy of relationships group stock performance according to at least an industry and economy sector to which a company is assigned, based on its products or services.

43. The method of claim 33, further including a user predefining one or more specified events to be monitored, upon the occurrence of which a news report is to be sent to the user.

44. The method of claim 33, wherein generating a news report further includes adapting the report for a multiplicity of media and transmitting over each of said media a report adapted for that medium.

45. The method of claim 44, wherein, for at least one of said media, adapting the report includes omitting at least a portion of information which is included in a report adapted for another medium.

46. The method of claim 33, wherein generating a news report further includes adapting the report for a medium selected by a user from a list of available media and transmitting over the selected medium a report adapted for the selected medium.

47. The method of claim 33, wherein the domain-specific news information pertains to sports news and statistics.

48. The method of claim 33, wherein the act of generating the news report further comprises generating the news report based in part upon a request from a user.
